(19) United States
(12) Patent Application Publication
(10) Pub. No.: US 2026/0204145 A1
(43) Pub. Date: Jul. 16, 2026

(54) ELECTRONIC DEVICE AND METHOD FOR PROVIDING HAPTIC DATA FOR GUIDING MOTION

(71) Applicant: Samsung Electronics Co., Ltd., Suwon-si (KR)

(72) Inventors: Yunkyun HAN, Suwon-si (KR); Sungchull LEE, Suwon-si (KR); Byungki HWANG, Suwon-si (KR)

(21) Appl. No.: 19/564,907

(22) Filed: Mar. 12, 2026

Related U.S. Application Data
(63) Continuation of application No. PCT/KR2024/014417, filed on Sep. 24, 2024.

(30) Foreign Application Priority Data
Nov. 22, 2023 (KR) 10-2023-0163842
Jan. 8, 2024 (KR) 10-2024-0003211

(51) Int. Cl. G08B 6/00; G06F 3/0482; G06F 3/0484; G06T 7/20; G09B 19/00

(52) U.S. Cl. CPC G08B 6/00; G06F 3/0482; G06F 3/0484; G06T 7/20; G06T 2207/10016; G06T 2207/30196; G09B 19/0015; G09B 19/003

(57) ABSTRACT

An electronic device includes at least one processor and a memory for storing instructions. The instructions, when executed individually and/or collectively by the at least one processor, cause the electronic device to: acquire a video and haptic data; generate a group of external electronic devices; allocate objects included in the video to the external devices; transmit the haptic data to the external electronic devices; and based on receiving a first input for playing the video and outputting the haptic data, transmit, to the external electronic devices, a signal for initiating the output of the haptic data.

### CROSS-REFERENCE TO RELATED APPLICATIONS

This application is a continuation International Application No. PCT/KR2024/014417 designating the United States, filed on Sep. 24, 2024, in the Korean Ministry of Intellectual Property Receiving Office and claiming priority to Korean Patent Application Nos. 10-2023-0163842, filed on Nov. 22, 2023, and 10-2024-0003211, filed on Jan. 8, 2024, in the Korean Ministry of Intellectual Property, the disclosures of each of which are incorporated by reference herein in their entireties.

### BACKGROUND

### Field

The present disclosure relates to an electronic device and a method for providing haptic data for guiding motion.

### Description of Related Art

An electronic device may display, through a display device, an object performing various motions (e.g., exercise or dance). For example, the object may be an instructor, an image, and/or a character performing a designated motion. The electronic device may provide a program that helps users learn the motion by following the motion of the object.

The above-described information may be provided as related art for the purpose of helping the understanding of the present disclosure. No assertion or determination is raised as to whether any of the above-described content may be applied as prior art related to the present disclosure.

### SUMMARY

According to an example embodiment, an electronic device is provided. The electronic device may comprise a display. The electronic device may comprise a camera. The electronic device may comprise wireless communication circuitry configured to wirelessly connect with external electronic devices. The electronic device may comprise at least one processor comprising processing circuitry. The electronic device may comprise memory storing instructions. The instructions, when executed by the at least one processor, individually and/or collectively, may cause the electronic device to: obtain a video through the camera, obtain haptic data related to motions of objects included in the video, generate a group of the external electronic devices connected through the wireless communication circuitry, assign one object among the objects to each of the external electronic devices, transmit haptic data corresponding to the assigned one object to each of the external electronic devices, and transmit a signal for initiating output of the haptic data corresponding to the one object to each of the external electronic devices, based on receiving a first input for playback of the video and for outputting the haptic data.

According to an example embodiment, a method of operating an electronic device is provided. The method may comprise: obtaining a video and haptic data; generating a group of one or more external electronic devices for guiding motions of one or more objects included in the video; assigning one object among the one or more objects to each of the one or more external electronic devices; transmitting, to each of the one or more external electronic devices, the haptic data corresponding to the one object assigned to each of the one or more external electronic devices; and transmitting, to each of the one or more external electronic devices, a signal for initiating output of the haptic data corresponding to the one object, based on receiving a first user input for playback of the video and for outputting the haptic data.

According to an example embodiment, an electronic device is provided. The electronic device may comprise at least one processor comprising processing circuitry. The electronic device may comprise memory storing instructions. The instructions, when executed by the at least one processor individually and/or collectively, may cause the electronic device to: obtain a video and haptic data, generate a group of external electronic devices for guiding motions of one or more objects included in the video, assign one object among the one or more objects to the one or more external electronic devices, transmit the haptic data corresponding to the one object assigned to the external electronic device to the external electronic device, and transmit a signal for initiating output of the haptic data corresponding to the one object to the external electronic device, based on receiving a first user input for playback of the video and for outputting the haptic data.

According to an example embodiment, a non-transitory computer-readable storage medium is provided. The non-transitory computer-readable storage medium may store a program including instructions. The instructions, when executed by at least one processor, comprising processing circuitry, of an electronic device individually and/or collectively, may cause the electronic device to: obtain a video and haptic data; generate a group of one or more external electronic devices for guiding motions of one or more objects included in the video; assign one object among the one or more objects to the one or more external electronic devices; transmit, to the one or more external electronic devices, the haptic data corresponding to the one object assigned to the one or more external electronic devices; and transmit a signal for initiating output of the haptic data corresponding to the one object to the one or more external electronic devices, based on receiving a first user input for playback of the video and for outputting the haptic data.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of an example electronic device in a network environment according to various example embodiments.

FIG. 2 is a block diagram illustrating an example configuration of a system for guiding motions of users using an electronic device according to various example embodiments.

FIG. 3A is a diagram illustrating an example process in which a haptic notification is generated based on a video according to various example embodiments.

FIG. 3B is a block diagram illustrating an example configuration of an external electronic device according to various example embodiments.

FIG. 4 is a diagram illustrating example haptic notifications according to types of haptic data according to various example embodiments.

FIG. 5 is a diagram illustrating an example of haptic notification according to haptic data generated based on video according to various example embodiments.

FIG. 6 is a signal flow diagram illustrating an example operation of an electronic device and operations of one or more external electronic devices for guiding motions according to various example embodiments.

FIG. 7A is a diagram illustrating an example UI displayed on an external electronic device for joining a group according to various embodiments.

FIG. 7B is a diagram illustrating an example UI displayed on an external electronic device for selecting an object according to various example embodiments.

FIG. 8 is a diagram illustrating an example UI displayed on an external electronic device according to various embodiments.

FIG. 9A is a diagram illustrating an example state in which an electronic device mirrors a video to a display device according to various example embodiments.

FIG. 9B is a block diagram illustrating an example configuration of an example external electronic device according to various example embodiments.

FIG. 9C includes graphs illustrating example data obtained through a sensor of an external electronic device according to various example embodiments.

FIG. 9D is a diagram illustrating an example process in which an external electronic device obtains data related to motion of a user according to various example embodiments.

FIG. 10 is a flowchart illustrating an example operation in which an electronic device calculates a ranking based on similarity data and displays the calculated ranking on a video according to various example embodiments.

FIG. 11A is a flowchart illustrating an example operation in which an electronic device provides feedback according to various example embodiments.

FIG. 11B is a diagram illustrating similarity with respect to a timeline according to various example embodiments.

### DETAILED DESCRIPTION

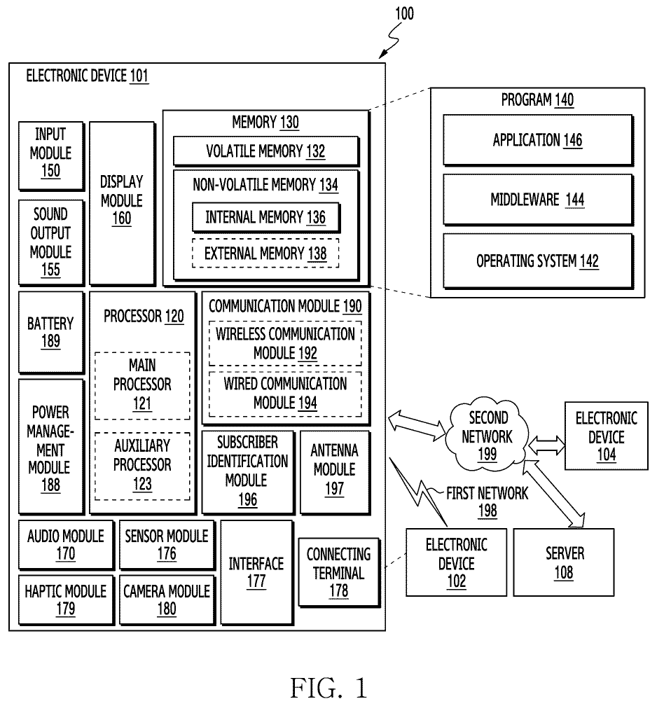

FIG. 1 is a block diagram illustrating an example electronic device 101 in a network environment 100 according to various example embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108.

According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example.

The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

According to an embodiment, an event performed by one or more objects may require harmony of motions of the one or more objects.

According to an embodiment, an electronic device 101 may provide learning for motions performed by one or more objects included in a video. The one or more objects may be referred to as an object capable of expressing motion, such as a person (e.g., an instructor), a virtual object (e.g., an image, a character, or an avatar), and/or an animal included in the video. A user may be provided with learning for motions by watching and following the motions performed by the one or more objects included in the video. The one or more objects may be singular or may be plural.

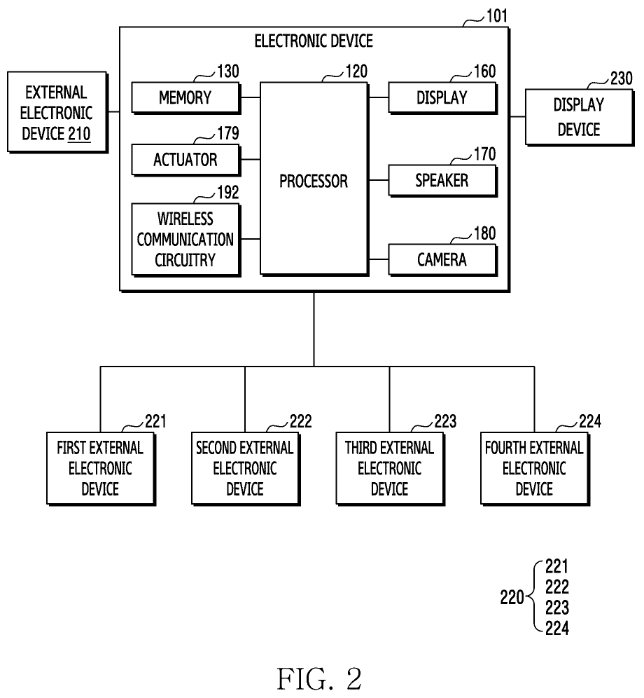

For example, a group dance performed by a plurality of objects may achieve harmony by performing not only unified motions of the plurality of objects, but also unique motion assigned to each object at an accurate timing. The electronic device 101 according to an embodiment may provide haptic data for guiding motions of each of the one or more objects. The electronic device 101 according to an embodiment may provide feedback for motion of each of one or more users from one or more external electronic devices (e.g., one or more external electronic devices 220 of FIG. 2). The above-described group dance is an example of learning for motion that may be provided through a video, and is not limited thereto. The electronic device 101 according to an embodiment may be used to provide not only learning for motion such as group dance, yoga, fitness, and/or gymnastics, but also various learning such as playing a musical instrument.

FIG. 2 is a block diagram illustrating an example configuration of a system for guiding motions of users using an electronic device according to various example embodiments.

Referring to FIG. 2, an electronic device 101 according to an embodiment may include at least one processor (e.g., the processor 120 of FIG. 1) and memory (e.g., the memory 130 of FIG. 1).

Any function or operation described in the present disclosure may be processed by the processor 120. The processor 120 may include various circuitry that performs processing, and includes an application processor (AP) (e.g., a central processing unit (CPU)), a communication processor (CP) (e.g., a modem), a graphics processing unit (GPU), a neural processing unit (NPU) (e.g., an artificial intelligence (AI) chip), a wireless-fidelity (Wi-Fi) chip, a Bluetooth® chip, a global positioning system (GPS) chip, a near field communication (NFC) chip, connectivity chips, a sensor controller, a touch controller, a finger-print sensor controller, a display drive integrated circuit (DDI), an audio CODEC chip, a universal serial bus (USB) controller, a camera controller, an image processing IC, a microprocessor unit (MPU), a system on chip (SoC), an integrated circuit (IC), and/or similar circuitry thereto and may be configured to operate as described above with reference to FIG. 1.

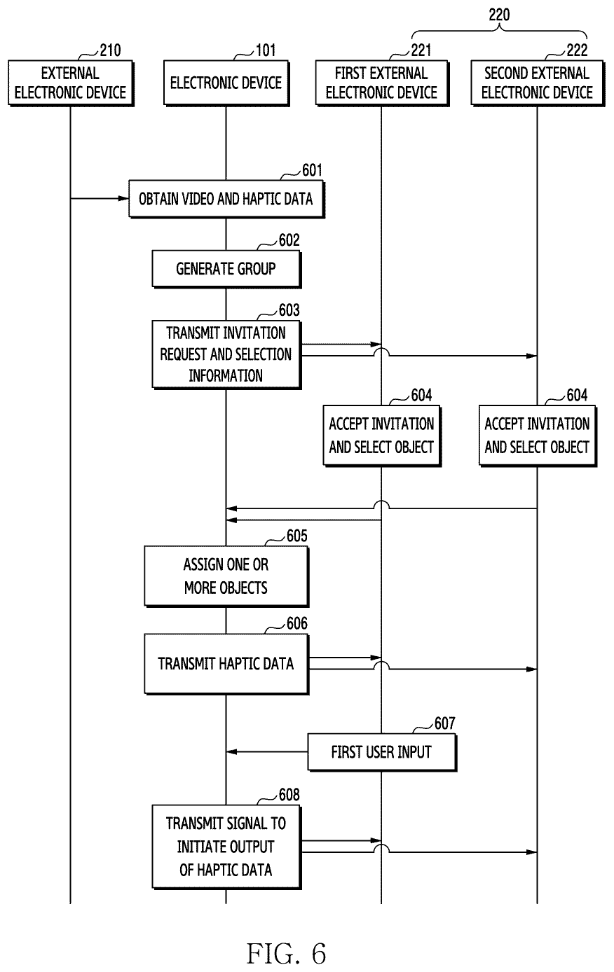

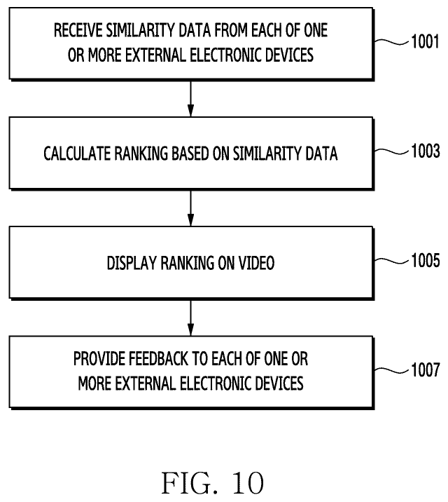

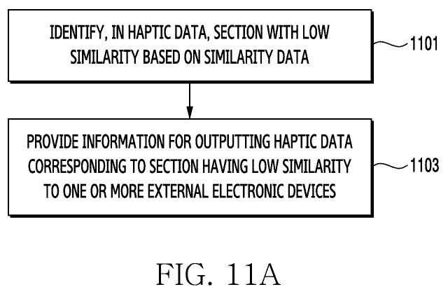

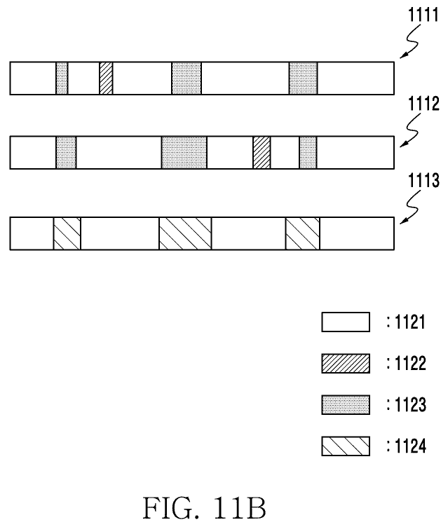

For example, the memory 130 may store instructions. The instructions stored in the memory 130, when executed by the processor 120 individually or collectively, may cause operations of the electronic device 101. For example, the instructions, when executed by the processor 120 individually or collectively, may cause the electronic device 101 to perform operations described in FIG. 6, FIG. 10, and FIG. 11A.

The electronic device 101 according to an embodiment may further include wireless communication circuitry (e.g., the wireless communication module 192 of FIG. 1), a display (e.g., the display module 160 of FIG. 1), a speaker (e.g., the audio module 170 of FIG. 1), a camera (e.g., the camera module 180 of FIG. 1), and/or an actuator (e.g., the haptic module 179 of FIG. 1).

For example, the wireless communication circuitry 192 may be used to communicate with one or more external electronic devices 220 and another external electronic device 210 (e.g., a server, a storage device (e.g., a USB), a smartphone, a tablet, a computer, or a laptop). The electronic device 101 may download a video and/or haptic data from the external electronic device 210 using the wireless communication circuitry 192. The electronic device 101 may transmit haptic data to the one or more external electronic devices 220 and broadcast a signal for initiating output of the haptic data using the wireless communication circuitry 192. The electronic device 101 may communicate with the one or more external electronic devices 220 using short-range wireless communication (e.g., Bluetooth communication).

For example, the display 160 and/or the speaker 170 may be controlled by the processor 120. The display 160 may be configured to display a video based on a control signal of the processor 120. The speaker 170 may be configured to output audio included in the video based on a control signal of the processor 120. The actuator 179 may provide a haptic notification by generating vibration.

For example, the external electronic device 210 may provide a video. The video may be content including one or more objects and may be referred to as a video related to an event performed by one or more objects. For example, the video may include a video related to a group dance in which one or more objects dance to music. For example, the video may be a stage video in which one or more objects dance to music, or a practice video in which one or more objects practice choreography. Hereinafter, in the present disclosure, a group dance video is described as an example of content, but the disclosure not limited thereto. The group dance to be described below may be replaced with an event performed by one or more objects. For example, the content may be replaced with a play, a musical, a group exercise, fitness, yoga, or a performance (e.g., playing a musical instrument).

The electronic device 101 according to an embodiment may include the camera 180. The camera 180 may be configured to generate an image and/or a video by photographing a subject. For example, the electronic device 101 may generate a video related to an event performed by one or more objects by photographing the one or more objects using the camera 180. For example, when a user records a performance in which a plurality of members dance at a concert using the electronic device 101, a video including a plurality of objects corresponding to the plurality of members may be generated. For example, the electronic device 101 may generate haptic data and/or reference data from a video generated through the camera 180 using an artificial intelligence model.

According to an embodiment, the external electronic device 210 may provide haptic data based on a video. The haptic data may be referred to as haptic data generated based on motions of each of one or more objects included in the video. For example, the external electronic device 210 may extract motions of each of the one or more objects using an artificial intelligence model and generate haptic data based on the extracted motions. When the one or more objects are plural, the haptic data may be plural. For example, when the video is a video in which four objects dance to music, the artificial intelligence model may extract motions of each of the four objects over time.

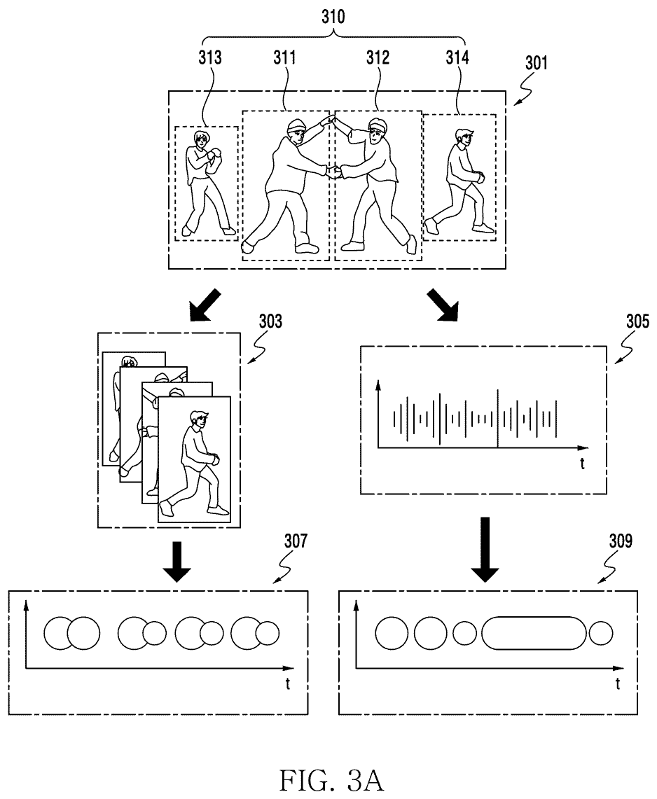

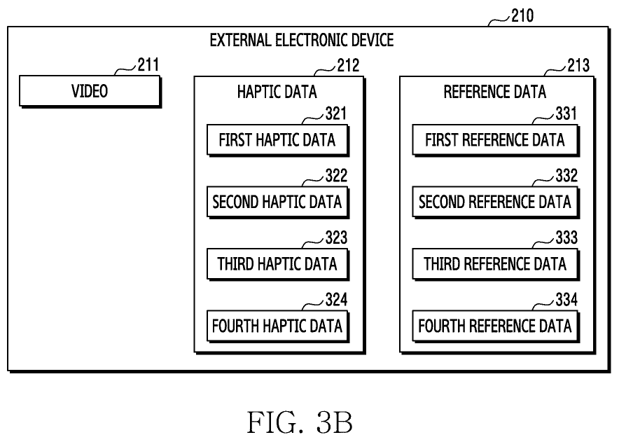

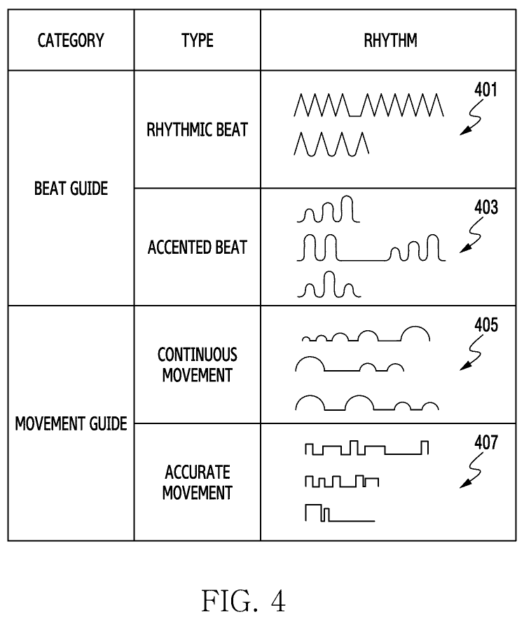

The artificial intelligence model may generate haptic data based on each of the extracted motions. For example, the artificial intelligence model may extract a first motion of a first object and generate first haptic data based on the first motion. The artificial intelligence model may extract a second motion of a second object and generate second haptic data based on the second motion. When the motion of the first object and the motion of the second object are not identical over an entire time, the first haptic data and the second haptic data may be different. The haptic data will be described in greater detail below with reference to FIG. 4. In terms of an artificial intelligence model generating haptic data from a video, the artificial intelligence model may be referred to as generative artificial intelligence, but is not limited thereto. The external electronic device 210 may provide reference data based on the haptic data. The reference data will be described in greater detail below with reference to FIG. 3B.

In the above-described example embodiment, the external electronic device 210 was described as generating haptic data using an artificial intelligence model, but is not limited thereto. According to an embodiment, the electronic device 101 may generate haptic data from a video. For example, the processor 120 may extract motions of each of one or more objects included in the video and generate haptic data based on each of the motions. The generated haptic data may be stored in the memory 130.

According to an embodiment, the electronic device 101 may download a video and haptic data from the external electronic device 210 through the wireless communication circuitry 192. For example, the electronic device 101 may download a video and haptic data stored in the external electronic device 210 for group dance practice of one or more users. As described above, the electronic device 101 may also generate haptic data from a video. For example, the electronic device 101 may generate haptic data by extracting motions of one or more objects included in the video using an artificial intelligence model.

According to an embodiment, the electronic device 101 may be operatively coupled with a display device 230. For example, the electronic device 101 may mirror content (e.g., a video) displayed on the display 160 of the electronic device 101 to the display device 230. The electronic device 101 may mirror the video to the display device 230 such that one or more users may watch the video and practice group dance. The display device 230 is a device capable of providing a display screen larger than that of the electronic device 101, and one or more users may practice motion (e.g., the group dance) while watching the mirrored video.

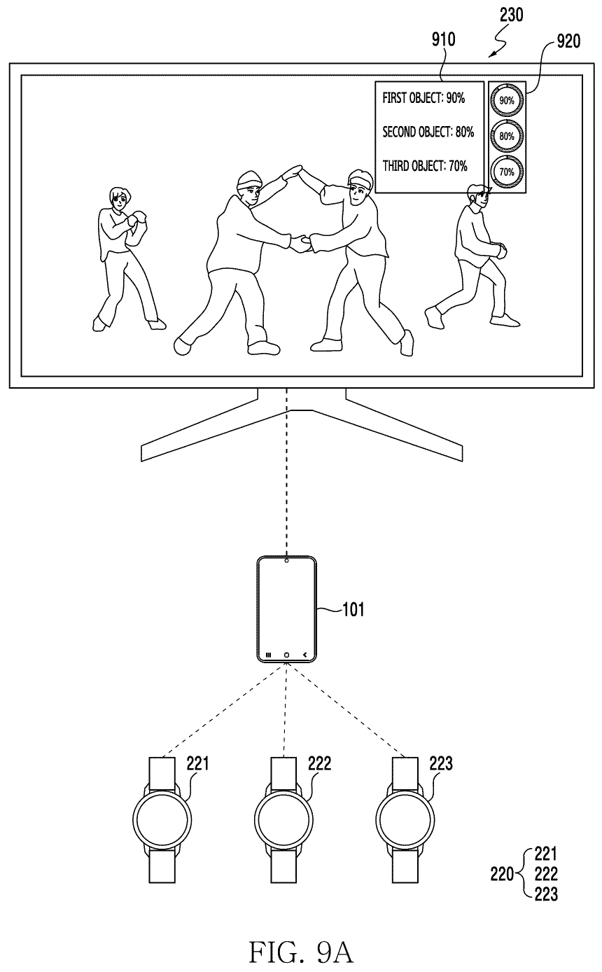

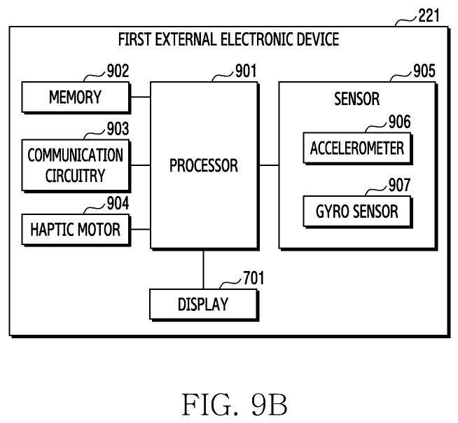

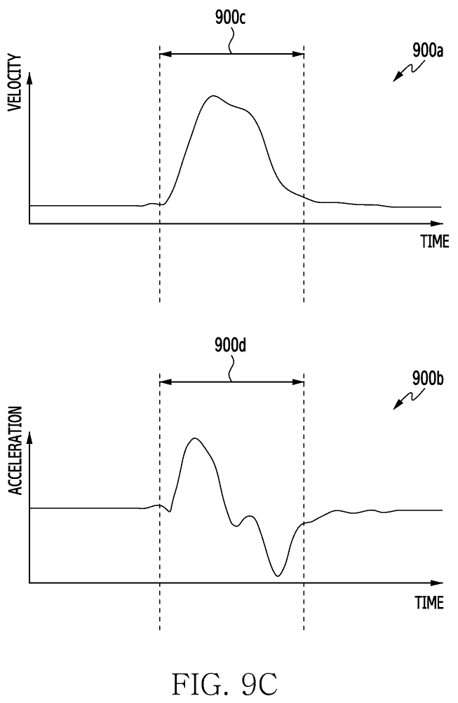

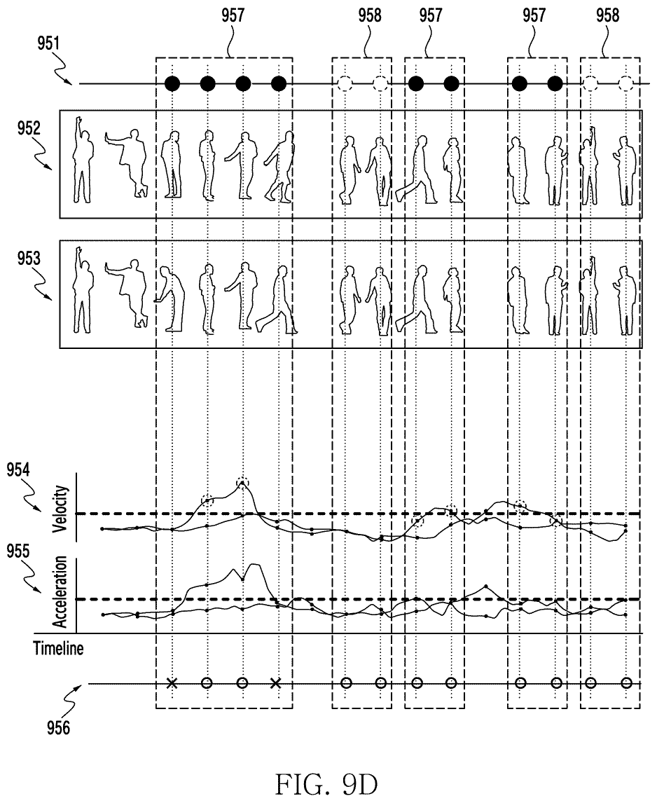

According to an embodiment, the electronic device 101 may communicate with one or more external electronic devices 220. The electronic device 101 may transmit haptic data downloaded from the external electronic device 210, or haptic data generated by the electronic device 101 using an artificial intelligence model to the one or more external electronic devices 220. Each of the one or more external electronic devices 220 may receive haptic data from the electronic device 101 and provide a haptic notification based on the received haptic data. For example, the one or more external electronic devices 220 may include a vibration motor (e.g., a vibration motor 904 of FIG. 9B) for providing a haptic notification.

Haptic data generated based on a video may guide motions of one or more users. The haptic data is not data for merely providing a simple haptic notification, but may be configured to provide various types of haptic notifications such that users may perform designated motions at designated timings. The one or more external electronic devices 220 may guide motions of one or more users who own the one or more external electronic devices 220 by providing haptic notification.

According to an embodiment, the one or more external electronic devices 220 may include wearable devices worn by one or more users practicing a group dance. For example, the one or more external electronic devices 220 may include, but are not limited to, a smartwatch worn on a wrist, a smart earring worn on an ear, an augmented reality (AR) device or a virtual reality (VR) device worn on a body of a user, and/or a smart ring worn on a finger, or the like. For example, the one or more external electronic devices 220 may include a mixed reality (MR) device and/or an extended reality (XR) device including video see-through (VST) and/or optical see-through (OST).

According to an embodiment, the one or more external electronic devices 220 worn or held by each of one or more users for practicing group dance may be of different types. For example, a first external electronic device 221 and a second external electronic device 222 may be smartwatches, a third external electronic device 223 may be a smart ring, and a fourth external electronic device 224 may be AR glasses. Since a wearable device is worn on a body of a user, the wearable device may guide motions of the user through a haptic notification.

Hereinafter, a haptic notification generated based on a video will be described in greater detail.

FIG. 3A is a diagram illustrating an example process in which a haptic notification is generated based on a video according to various example embodiments. FIG. 3B is a block diagram illustrating an example configuration of an example external electronic device according to various example embodiments.

Reference numeral 301 of FIG. 3A illustrates a video. Referring to 301 of FIG. 3A, according to an embodiment, the video may include a video in which a plurality of people are dancing. In this case, an electronic device 101 may identify each of the plurality of people as objects 310. For example, the video may identify objects 310 corresponding to each of four people and distinguish each of the objects as a first object 311, a second object 312, a third object 313, and a fourth object 314. The video may include audio. According to an embodiment, an artificial intelligence model may be used to generate haptic data based on the video.

Reference numeral 303 of FIG. 3A illustrates a process of identifying movements (motions) of the objects corresponding to each of the four people in the video and generating haptic data based on each of the motions. Referring to 303 of FIG. 3A, according to an embodiment, the artificial intelligence model may distinguish each of the four objects from the video and extract motions based on movements from the four objects. For example, the artificial intelligence model may extract motions through an operation of detecting the four objects in the video (e.g., object detection), recognizing motions of each of the four objects (e.g., action recognition), and tracking motions of each of the four objects (e.g., motion tracking). The artificial intelligence model may generate motion data over time based on the extracted motions, and may generate haptic data 307 based on the motion data.

In the above description, it has been described that four people are included in the video and motions of each of the four people are extracted, but the disclosure is not limited thereto. For example, in a case of a video recorded of an actual person, objects 310 may be identified from the person (or people) included in the video, but is not limited thereto. For example, the video may include various objects, such as a non-real virtual object (e.g., a character, an avatar, or a 3D model) or an object (e.g., an animal) distinguished from a person, and the electronic device 101 may obtain haptic data corresponding to motions of the various objects.

Reference numeral 305 of FIG. 3A illustrates a process of generating haptic data based on amplitude data regarding audio extracted from the video. Referring to 305 of FIG. 3A, the artificial intelligence model may extract audio from the video. For example, the artificial intelligence model may divide the video into consecutive frames, separate audio channels from the frames, and then extract audio data from each of the audio channels. However, the disclosure is not limited thereto. The extracted audio may be represented as amplitude data over time. The amplitude data may represent melody, meter, beat, and rhythm. When a strong sound is provided at a specific timing, the amplitude data may represent a large amplitude value at the specific timing. The amplitude data may represent a high frequency at a timing at which a fast-beat sound is provided, and the amplitude data may represent a low frequency at a timing at which a slow-beat sound is provided. The artificial intelligence model may generate haptic data 309 based on the amplitude data. The haptic data 309 illustrated in FIG. 3A is a diagram visualizing haptic data providing vibration. For example, a type of an image included in the haptic data 309 may represent a type of vibration, a size of the image may represent intensity of vibration, and a length of the image may represent a duration of vibration. For example, as the size of the image (e.g., a diameter of a circle) increases, vibration of stronger intensity is provided, and as the length of the image (e.g., a length along an x-axis) increases, continuous vibration may be provided for a longer time. The haptic data 309 corresponding to a timeline of the video may be generated, and while the video is being played back, vibration may be provided at a timing corresponding to a timestamp of the video.

According to an embodiment, the artificial intelligence model may generate haptic data (e.g., haptic data 212 of FIG. 3B) for guiding motion based on the haptic data 307 based on motion data and the haptic data 309 based on amplitude data. For example, the haptic data may be generated by synthesizing the haptic data 307 and the haptic data 309. The haptic data 212 for guiding motion may be based on motions of each of the four objects and audio according to a playback time of the video.

According to an embodiment, the artificial intelligence model may generate haptic data corresponding to each target object. For example, haptic data corresponding to at least one object may be generated. For example, even when the amplitude data extracted from audio is identical, as illustrated in FIG. 3A, the motions of each of the four objects may be different. The artificial intelligence model may generate first haptic data corresponding to the first object 311 (e.g., first haptic data 321 of FIG. 3B), second haptic data corresponding to the second object 312 (e.g., second haptic data 322 of FIG. 3B), third haptic data corresponding to the third object 313 (e.g., third haptic data 323 of FIG. 3B), and fourth haptic data corresponding to the fourth object 314 (e.g., fourth haptic data 324 of FIG. 3B). However, the disclosure is not limited thereto. As described above, one or more objects 310 may be an object corresponding to an actual person, or may be one or more objects 310 corresponding to a virtual object (e.g., a character, an avatar, or a 3D model) or an object (e.g., an animal) distinguished from a person.

Referring to FIG. 3B, an external electronic device 210 may store a video 211, haptic data 212, and/or reference data 213 (e.g., including first reference data 331, second reference data 332, third reference data 333 and fourth reference data 334). According to an embodiment, the video 211, the haptic data 212, and the reference data 213 may be stored in the external electronic device 210 such as a server or another electronic device (e.g., a smartphone, a computer, and/or a storage device), but is not limited thereto. For example, the video 211, the haptic data 212, and/or the reference data 213 may be generated and stored by the electronic device 101, or the video 211, the haptic data 212, and/or the reference data 213 generated by another electronic device may be provided to the electronic device 101. For example, the video 211 may be a video recorded through a camera (e.g., the camera 180 of FIG. 2) of the electronic device 101, and the electronic device 101 may generate the haptic data 212 and/or the reference data 213 from the video.

According to an embodiment, the haptic data 212 may include haptic data corresponding to each of one or more objects (e.g., the one or more objects 310 of FIG. 3A) included in the video 211. According to an embodiment, when four objects are included in the video, the haptic data 212 may include first haptic data 321, second haptic data 322, third haptic data 323, and fourth haptic data 324. However, the four objects are merely an example and are not limited thereto. For example, the one or more objects 310 may include only one object, and in this case, the haptic data 212 may include haptic data corresponding to the one object. For example, the one or more objects 310 may include five or more objects, and in this case, the haptic data 212 may include haptic data corresponding to the five or more objects. Besides this, various embodiments may be possible.

According to an embodiment, an artificial intelligence model may generate the reference data 213, and the generated reference data 213 may be stored in the external electronic device 210. The reference data 213 may be referred to as data for providing similarity between motions guided by the haptic data 212 and actual measured motions of a user. For example, when the haptic data 212 is configured to take a specific motion at a specific timing, the reference data 213 may be configured as reference data for checking whether the user accurately performed the specific motion at the specific timing. For example, when the user performed an accurate motion at the specific timing, the motion of the user substantially corresponding to the reference data 213 may be measured. The similarity may be calculated through similarity between the reference data 213 and data measured by the actual motion of the user. The reference data 213 may be used to provide feedback to one or more users. For example, the electronic device 101 may download the reference data 213 from the external electronic device 210 together with the video 211 and the haptic data 212.

Hereinafter, types of the haptic data 212 generated by the artificial intelligence model are described in greater detail.

FIG. 4 is a diagram illustrating example haptic notifications according to types of haptic data according to various example embodiments.

In FIG. 4, an x-axis represents time, and a y-axis represents intensity of a haptic notification. Types of haptic data illustrated in FIG. 4 are merely examples and are not limited thereto.

According to an embodiment, haptic data generated by an artificial intelligence model may be classified into haptic data for guiding a beat or haptic data for guiding motion. Referring to FIG. 4, the haptic data may include first data, second data, third data, and fourth data.

According to an embodiment, the first data and the second data may be referred to as haptic data for guiding a beat. Reference numeral 401 of FIG. 4 is an image schematically illustrating a first haptic notification corresponding to the first data. The first data may be configured to provide haptic notifications at a constant intensity and at a constant cycle to guide rhythm. The first data may be referred to as a rhythm beat type. For example, when there is not much movement, the first data may be used to guide a main beat of music. For example, the first haptic notification may be provided while one or more objects are waiting in a rear row.

Reference numeral 403 of FIG. 4 is an image schematically illustrating a second haptic notification corresponding to the second data. The second data may be configured to provide haptic notifications having intensity that gradually increases at a constant cycle to guide an accent (or stress). The second data may be referred to as an accent beat type. For example, the second data may be used to guide entry at an accurate timing before entering an individual part. In the present disclosure, motion may be distinguished into a group part and an individual part. For example, the group part may be referred to as a part in which one or more objects perform substantially the same motion or a unified motion. For example, the individual part may be referred to as a part in which at least one object among the one or more objects performs a motion different from motions of remaining objects. For example, the second haptic notification may be provided immediately before one or more objects enter an individual part.

According to an embodiment, the third data and the fourth data may be referred to as haptic data for guiding motion.

Reference numeral 405 of FIG. 4 is an image schematically illustrating a third haptic notification corresponding to the third data. The third data may be configured to continuously provide haptic notifications having smoothly changing intensity to guide continuous movement. The third data may be referred to as a continuous movement type. The third haptic notification may be used to guide a smooth and continuously connected motion (e.g., legato). For example, the third haptic notification may be provided to guide continuous steps or a smoothly rotating motion.

Reference numeral 407 of FIG. 4 is an image schematically illustrating a fourth haptic notification corresponding to the fourth data. The fourth data may be configured to irregularly provide haptic notifications having strong intensity to guide accurate movement. The fourth data may be referred to as an accurate movement type. The fourth haptic notification may be used to guide a discontinuous motion (e.g., staccato). For example, the fourth haptic notification may be provided to guide motions including an accurate step, a jump, and a large movement.

For example, the haptic data may be stored in JSON format. Referring to [Table 1] below, types of haptic notifications may be distinguished by curly brackets, and each haptic notification may be stored according to its timestamp. One or more external electronic devices 220 may be configured to provide haptic notifications in a continuous stream based on haptic data in JSON format.

TABLE 1

[
{
/ output timestamp (ms)
timestamp: 3150,
/continuity
haptic_continuity: single,
/ haptic type
haptic_type_id: 5,
/ haptic intensity
haptic_intensity: 10
},
{
timestamp: 3870,
/ continuity
haptic_continuity: continuous,
haptic_type_id: 17,
/ haptic duration
haptic_duration: 3000,
}
]

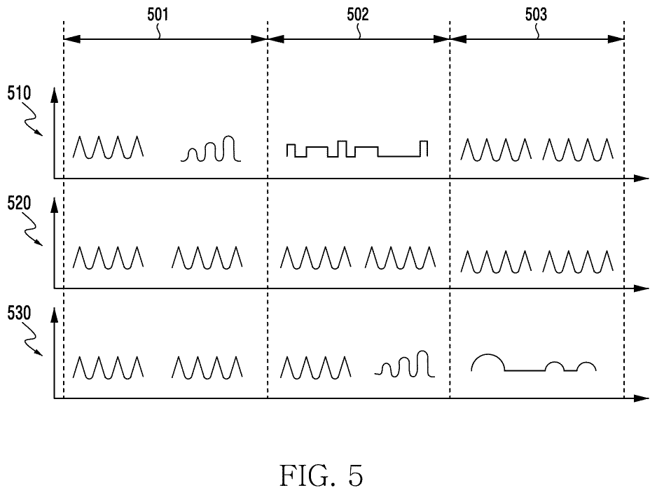

FIG. 5 is a diagram including graphs illustrating an example of haptic notifications according to haptic data generated based on a video according to various example embodiments.

According to an embodiment, an artificial intelligence model may generate haptic data corresponding to each of one or more objects included in a video. As described above, since motions of one or more objects are not always identical over time, haptic data corresponding to each of the one or more objects may be different. Since the haptic data corresponding to each of the one or more objects is different, haptic notifications corresponding to each of the one or more objects may be identical or may be different over time.

Referring to FIG. 5, when the one or more objects include three objects (e.g., a first object, a second object, and a third object), haptic notifications corresponding to haptic data may be different according to haptic data corresponding to each of the three objects. For example, the haptic notifications may be distinguished into three sections over time. For example, the three sections may include a first section 501, a second section 502, and a third section 503. A haptic notification 510 of FIG. 5 is an image schematically illustrating a haptic notification corresponding to haptic data corresponding to the first object over time. A haptic notification 520 of FIG. 5 is an image schematically illustrating a haptic notification corresponding to haptic data corresponding to the second object over time. A haptic notification 530 of FIG. 5 is an image schematically illustrating a haptic notification corresponding to haptic data corresponding to the third object over time.

For example, the first section 501 may be a section in which the first object, the second object, and the third object all perform motions of a group part. In the first section 501, the first object, the second object, and the third object may all perform the same motion or a unified motion. To guide the same motion or the unified motion to the first object, the second object, and the third object, the haptic notification 510, the haptic notification 520, and the haptic notification 530 may be substantially identical in the first section 501. For example, the haptic notification 510, the haptic notification 520, and the haptic notification 530 may be first haptic notifications corresponding to first data for guiding rhythm. For example, the haptic data corresponding to the first object, the haptic data corresponding to the second object, and the haptic data corresponding to the third object may include the first data in the first section 501.

For example, when the first object enters an individual part in the second section 502 following the first section 501, the haptic notification 510 may be partially different from the haptic notification 520 and the haptic notification 530. For example, the haptic data corresponding to the first object may include second data in which intensity of a haptic notification becomes stronger to guide entry into the individual part before the first section 501 ends. The haptic notification 510 may provide a second haptic notification corresponding to the second data before the first section 501 ends.

For example, the second section 502 may be a section in which the first object performs a motion of an individual part and the second object and the third object perform motions of a group part. In the second section 502, the first object may perform a motion different from that of the second object and the third object. The haptic notification 510 may be different from the haptic notification 520 and the haptic notification 530. For example, when the individual part of the first object is a discontinuous motion in the second section 502, the haptic data corresponding to the first object may include fourth data in the second section 502. To guide the same motion in the second section 502, the haptic data corresponding to the second object and the haptic data corresponding to the third object may include the first data in the second section 502. In the second section 502, the haptic notification 520 and the haptic notification 530 may be substantially identical.

For example, when the third object enters an individual part in the third section 503 following the second section 502, the haptic notification 530 may be partially different from the haptic notification 520. For example, the haptic data corresponding to the third object may include second data in which intensity of a haptic notification becomes stronger to guide entry into the individual part before the second section 502 ends. The haptic notification 530 may provide a second haptic notification corresponding to the second data before the second section 502 ends.

For example, the third section 503 may be a section in which the third object performs a motion of an individual part and the first object and the second object perform motions of a group part. In the third section 503, the third object may perform a motion different from that of the first object and the second object. The haptic notification 530 may be different from the haptic notification 510 and the haptic notification 520. For example, when the individual part of the third object is a smooth and continuous motion in the third section 503, the haptic data corresponding to the third object may include third data in the third section 503. To guide the same motion in the third section 503, the haptic data corresponding to the first object and the haptic data corresponding to the second object may include the first data in the third section 503. In the third section 503, the haptic notification 510 and the haptic notification 520 may be substantially identical.

As described above, haptic data corresponding to each of one or more objects may be determined based on motions of each of the one or more objects. An electronic device 101 according to an embodiment may assign each of the one or more objects to each of one or more external electronic devices 220. The electronic device (e.g., the electronic device 101 of FIG. 2) according to an embodiment may transmit haptic data corresponding to an assigned object to the one or more external electronic devices (e.g., the one or more external electronic devices 220 of FIG. 2). The one or more external electronic devices 220 may receive haptic data corresponding to the assigned object. When a video is played back, the video may be mirrored through a display device (e.g., the display device 230 of FIG. 2), and one or more users may perform motions while being provided with respective haptic notifications. For example, one or more external electronic devices 220 worn or held by each of one or more users practicing a group dance may guide motions of each of the one or more users through a haptic notification corresponding to an assigned object.

Hereinafter, an operation of the electronic device 101 and operations of the one or more external electronic devices 220 according to an example embodiment will be described in greater detail.

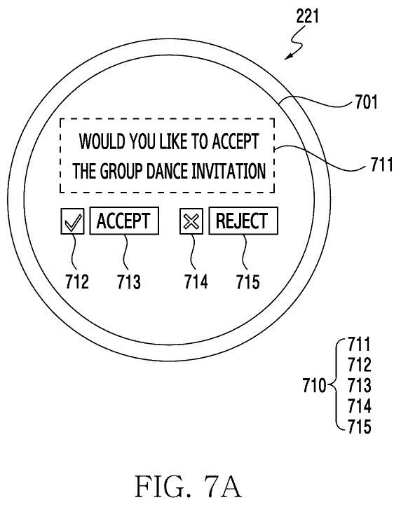

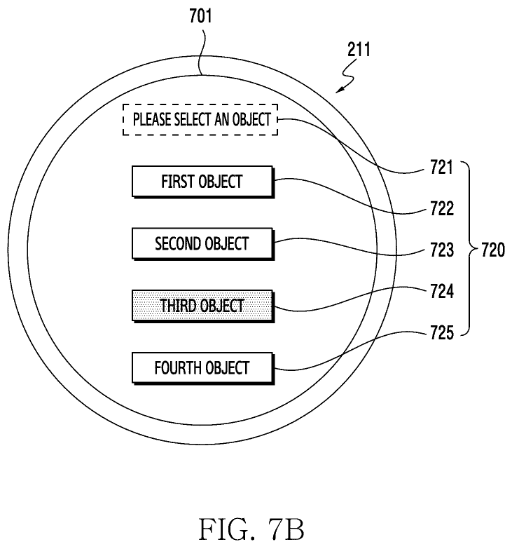

FIG. 6 is a signal flow diagram illustrating an example operation of an electronic device and operations of one or more external electronic devices for guiding motions according to various example embodiments. FIG. 7A is a diagram illustrating an example UI displayed on an external electronic device for joining a group according to various example embodiments. FIG. 7B is a diagram illustrating an example UI displayed on an external electronic device for selecting an object according to various example embodiments.

According to an embodiment, instructions stored in memory (e.g., the memory 130 of FIG. 2), when executed by a processor (e.g., the processor 120 of FIG. 2) individually and/or collectively, may cause an electronic device 101 to perform operations described in FIG. 6. In FIG. 6, one or more external electronic devices 220 are illustrated as including a first external electronic device 221 and a second external electronic device 222, but this is merely for convenience of explanation and the disclosure is not limited thereto.

In operation 601, the electronic device 101 may, according to an embodiment, obtain a video and haptic data from an external electronic device 210.

For example, the processor 120, when executing instructions stored in the memory 130, may download a video (e.g., the video 211 of FIG. 3B) and haptic data (e.g., the haptic data 212 of FIG. 3B) from the external electronic device 210 through wireless communication circuitry (e.g., the wireless communication circuitry 192 of FIG. 2). For example, the video may be a group dance video including one or more objects. The haptic data may be haptic data generated by extracting motions of each of the one or more objects in the video using an artificial intelligence model and based on the extracted motions. The haptic data may include haptic data corresponding to each of the one or more objects.

According to an embodiment, the external electronic device 210 may include various electronic devices such as a server, a storage device (e.g., a USB), a smartphone, a tablet, a computer, or a laptop, and is not limited to a specific electronic device. The electronic device 101 may obtain a video and haptic data from the external electronic device 210 through various wireless communication methods (e.g., Wi-Fi, 3G, LTE, or 5G) or a wired communication method, and is not limited to the described example.

In operation 602, the electronic device 101 may generate a group of one or more external electronic devices 220 for guiding motions of each of the one or more objects.

For example, the processor 120, when executing the instructions stored in the memory 130, may generate a group for guiding motions of each of the one or more objects included in the video. When generating the group, the number of one or more external electronic devices 220 that may participate in the group may be set. For example, when there are four objects in the video, the number of one or more external electronic devices 220 that may participate in the group may be set to four. However, the disclosure is not limited thereto.

For example, when generating the group, the processor 120 may set the number of one or more external electronic devices 220 that may participate in the group. For example, when generating the group, a user of the electronic device 101 may set the number of participants by considering the number of one or more objects included in the video. For example, when eight users participate in practicing a group dance performed by five objects, the number of objects that may be assigned may be fewer than the number of participants. In this case, since proper practice of the group dance may be difficult, setting the number of participants that may participate in the group may be necessary. The number of participants may be set as the number of one or more external electronic devices 220 that may participate in the group.

In operation 603, the electronic device 101 may transmit an invitation request and information to be used for selecting an object to the one or more external electronic devices 220.

For example, the processor 120, when executing the instructions stored in the memory 130, may transmit an invitation request and information used for selecting an object to the one or more external electronic devices 220 through short-range wireless communication based on the generation of the group.

According to an embodiment, the invitation request may be referred to as transmission of information for displaying a user interface (UI) (e.g., a UI 710 of FIG. 7A) for joining the group to the one or more external electronic devices 220. For example, the one or more external electronic devices 220 may display the UI 710 on a display (e.g., a display 701 of FIG. 7A) of the one or more external electronic devices 220 based on receiving the information for displaying the UI 710.

In the present disclosure, the selection of an object may be referred to as a user selecting a specific object among the one or more objects in order to be provided with guidance on motions of the specific object. According to an embodiment, the information used for selecting an object may be information for selecting any one object among the one or more objects included in the video. For example, when the one or more objects include four objects, the information may include a name, a position, and/or selectability of the object.

In operation 604, the first external electronic device 221 and the second external electronic device 222 may accept the invitation based on the invitation request received from the electronic device 101, and may select any one object among the one or more objects based on the information to be used for selection received from the electronic device 101. For example, the first external electronic device 221 may select a first object, and the second external electronic device 222 may select a second object. The first external electronic device 221 may transmit information indicating acceptance of the invitation and information indicating selection of the first object to the electronic device 101. The second external electronic device 222 may transmit information indicating acceptance of the invitation and information indicating selection of the second object to the electronic device 101.

Referring to FIG. 7A, an external electronic device (e.g., the first external electronic device 221) may display the UI 710 based on receiving information for displaying the UI 710 for joining the group from the electronic device 101. For example, when the first external electronic device 221 is a smartwatch, the UI 710 may be displayed on a display 701 of the smartwatch. As illustrated in FIG. 7A, the UI 710 may include text 711 such as “Would you like to accept the group dance invitation?”. The UI 710 may include a first icon 712 and/or first text 713 for receiving a user input to accept the invitation and join the group. The UI 710 may include a second icon 714 and/or second text 715 for receiving a user input to reject the invitation and not join the group. The first external electronic device 221 may transmit to the electronic device 101 a signal indicating participation input through the first icon 712 and/or the first text 713 of the UI 710. The electronic device 101 may, based on receiving the signal indicating participation input through the UI 710 from any one of the one or more external electronic devices 220 (e.g., the first external electronic device 221), add the external electronic device (e.g., the first external electronic device 221) that transmitted the signal to the group.

Referring to FIG. 7B, an external electronic device (e.g., the first external electronic device 221) may, based on receiving information used for selecting any one object among the one or more objects from the electronic device 101, display a UI 720 for selecting the object on the display 701. As illustrated in FIG. 7B, the UI 720 may include text 721 such as “Please select an object”. For example, when the number of one or more external electronic devices 220 that may participate in the group generated in operation 602 is set to four, the UI 720 may include a first UI 722 for selecting a first object, a second UI 723 for selecting a second object, a third UI 724 for selecting a third object, and a fourth UI 725 for selecting a fourth object. When the third object is selected by another external electronic device (e.g., the second external electronic device 222), the third UI 724 may be deactivated, and the first UI 722, the second UI 723, and the fourth UI 725 may be activated. For example, each of the first UI 722, the second UI 723, and the fourth UI 725 may be labeled with names for distinguishing the one or more objects. For example, when the video is a group dance video of dance singers, each of the first UI 722, the second UI 723, and the fourth UI 725 may be labeled with actual names of the dance singers.

Referring back to FIG. 6, in operation 605, the electronic device 101 may assign the one or more objects to one or more external electronic devices 220.

For example, the processor 120, when executing the instructions stored in the memory 130, may assign the one or more objects to the first external electronic device 221 and the second external electronic device 222 based on information received from the first external electronic device 221 and the second external electronic device 222. For example, the processor 120 may assign the first object to the first external electronic device 221 and may assign the second object to the second external electronic device 222.

In operation 606, the electronic device 101 may transmit haptic data to the one or more external electronic devices 220.

For example, the processor 120, when executing the instructions stored in the memory 130, may transmit, to the one or more external electronic devices 220, haptic data corresponding to an object assigned to each of the one or more external electronic devices 220. For example, the processor 120 may transmit haptic data corresponding to the first object to the first external electronic device 221 and may transmit haptic data corresponding to the second object to the second external electronic device 222.

In operation 607, the first external electronic device 221 may transmit a first input (e.g., a first user input) to the electronic device 101.

For example, the first external electronic device 221 may be an external electronic device capable of controlling playback of the video among the one or more external electronic devices 220. For example, the first external electronic device 221 may be a wearable device owned by the user of the electronic device 101, but is not limited thereto. The first external electronic device 221 capable of controlling playback of the video may transmit the first user input for initiating playback of the video to the electronic device 101. For example, the first external electronic device 221 may, when receiving the first user input from the user, transmit the first user input to the electronic device 101.

In operation 608, the electronic device 101 may transmit a signal for initiating output of haptic data to all of the one or more external electronic devices 220, based on receiving the first user input for playback of the video and output of the haptic data.

For example, the processor 120, when executing the instructions stored in the memory 130, may broadcast the signal transmitted to the one or more external electronic devices 220, based on receiving the first user input. The one or more external electronic devices 220 may output the received haptic data based on the signal broadcast from the electronic device 101. For example, while outputting the haptic data, the one or more external electronic devices 220 may control a vibration motor (e.g., a vibration motor 904 of FIG. 9B) based on the haptic data.

For example, the first external electronic device 221 may guide motions of a first user wearing the first external electronic device 221 by providing a haptic notification based on first haptic data (e.g., the first haptic data 321 of FIG. 3B) corresponding to the first object. Since the first haptic data is based on a first motion of the first object, the first external electronic device 221 may guide motions of the first user to correspond to the first motion through the first haptic data. The second external electronic device 222 may guide motions of a second user wearing the second external electronic device 222 by providing a haptic notification based on second haptic data (e.g., the second haptic data 322 of FIG. 3B) corresponding to the second object. Since the second haptic data is based on a second motion of the second object, the second external electronic device 222 may guide motions of the second user to correspond to the second motion through the second haptic data.

According to an embodiment, since the first haptic data and the second haptic data are outputted based on the signal broadcast by the electronic device 101, the first haptic data and the second haptic data may be synchronized with each other. For example, a timestamp of the first haptic data and a timestamp of the second haptic data may be synchronized, thereby enabling one or more users to practice a group dance.

According to an embodiment, the electronic device 101 may be operatively connected with a display device 230. While the electronic device 101 performs playback of the video, the electronic device 101 may mirror the video to the display device (e.g., the display device 230 of FIG. 2). The display device 230 may display the video mirrored by the electronic device 101. One or more users may watch the video displayed on the display device 230 and practice a group dance using haptic notifications provided from the one or more external electronic devices 220. Since the one or more external electronic devices 220 do not provide identical haptic notifications but provide haptic notifications corresponding to selected objects, the electronic device 101 according to an embodiment may provide group dance practice in which motions of the one or more users are harmonized.

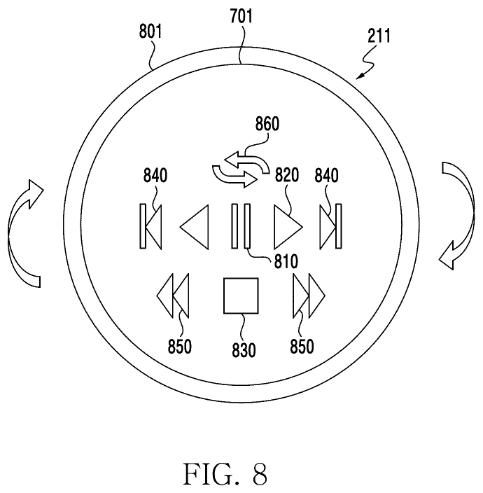

FIG. 8 is a diagram illustrating an example UI displayed on an external electronic device according to various example embodiments.

According to an embodiment, any one external electronic device (e.g., a first external electronic device 221) among one or more external electronic devices (e.g., the one or more external electronic devices 220 of FIG. 2) may control playback of a video. For example, the first external electronic device 221 may be an external electronic device capable of providing a first user input. The first user input capable of controlling playback of the video may be transmitted to an electronic device (e.g., the electronic device 101 of FIG. 2) through the first external electronic device 221.

Referring to FIG. 8, the first external electronic device 221 may control playback of the video. For example, controlling the playback of the video may include at least one of pausing the video, resuming playback of the paused video, stopping playback of the video, moving a timestamp of the video, adjusting a playback speed of the video, or repeating a designated section of the video. For example, moving the timestamp of the video may include a jump to skip a specific section of the video and/or a skip to skip a prelude or an intro clip.

According to an embodiment, the first external electronic device 221 may display a UI 800 for controlling the video on a display 701. The UI 800 may include a first UI 810 for pausing the video, a second UI 820 for resuming playback of the paused video, a third UI 830 for stopping playback of the video, a fourth UI 840 for moving a timestamp of the video, a fifth UI 850 for adjusting a playback speed of the video, and/or a sixth UI 860 for repeating a designated section of the video. However, the disclosure is not limited thereto. A second input (e.g., a second user input) for the first UI 810, the second UI 820, the third UI 830, the fourth UI 840, the fifth UI 850, and/or the sixth UI 860 may be transmitted to the electronic device 101. The electronic device 101 may control playback of the video based on receiving the second user input. For example, based on receiving a second user input for the first UI 810, the electronic device 101 may pause the video being played back. For example, based on receiving a second user input for the sixth UI 860, the electronic device 101 may repeatedly play back a designated section of the video. According to an embodiment, when the first external electronic device 221 is a smartwatch, the first external electronic device 221 may include a bezel 801 forming an edge. The bezel 801 may be rotatable with respect to the display 701. For example, through rotation of the bezel 801, either movement of a timestamp of the video or adjustment of a playback speed of the video may be controlled. For example, when the bezel 801 is rotated clockwise, the timestamp of the video may move backward or the playback speed of the video may increase. For example, when the bezel 801 is rotated counterclockwise, the timestamp of the video may move forward or the playback speed of the video may decrease. A second user input for controlling playback of the video may include rotating the bezel 801. The second user input for the bezel 801 may be transmitted to the electronic device 101. The electronic device 101 may control playback of the video based on receiving the second user input for the bezel 801.

According to an embodiment, the first external electronic device 221 capable of controlling playback of the video may be referred to as a leader device or a host device in terms of leading practice by controlling playback of the video. The remaining external electronic devices, excluding the first external electronic device 221 may be referred to as follower devices or guest devices.

FIG. 9A is a diagram illustrating an example state in which an electronic device mirrors a video to a display device according to various example embodiments. FIG. 9B is a block diagram illustrating an example configuration of an example external electronic device according to various example embodiments. FIG. 9C includes graphs illustrating an example of data obtained through a sensor of an external electronic device according to various example embodiments. FIG. 9D is a diagram illustrating an example process in which an external electronic device obtains data related to motion of a user according to various example embodiments.

Referring to FIG. 9A, an electronic device 101 according to an embodiment may mirror a video to a display device 230. Since the display device 230 may provide a large display screen, it may be easy for one or more users to watch the video and follow motions.

For example, the electronic device 101 may initiate playback of the video based on receiving a first user input. When playback of the video is initiated, the electronic device 101 may broadcast a signal for initiating output of haptic data such that the output of the haptic data transmitted to each of one or more external electronic devices 220 is initiated. The one or more external electronic devices 220 may output haptic notifications synchronized by the signal. Timestamps of the synchronized haptic notifications may correspond to a timestamp of the video, with the haptic notifications transmitted to each of the one or more external electronic devices 220. For example, a timestamp of first haptic data and a timestamp of second haptic data may be synchronized with a timestamp of the video, thereby enabling one or more users to practice a group dance.

The electronic device 101 according to an embodiment may receive, from the one or more external electronic devices 220, similarity data indicating similarity between data related to motions of users and haptic data.

For example, when transmitting haptic data to the one or more external electronic devices 220, the electronic device 101 may transmit reference data (e.g., the reference data 213 of FIG. 3B) together with the haptic data (e.g., the haptic data 212 of FIG. 3B). The one or more external electronic devices 220 may receive the reference data from the electronic device 101. As described above, the reference data may be referred to as data for providing similarity between motions guided by haptic data and data related to actual measured motions of a user.

Each of the one or more external electronic devices 220 may measure motions of users and generate data related to the motions of the users. The one or more external electronic devices 220 may calculate similarity between the reference data and the data related to the measured motions. Referring to FIG. 9B, the one or more external electronic devices 220 (e.g., a first external electronic device 221) may include a sensor (e.g., a sensor 905 of FIG. 9B) for measuring motions of users. For example, the sensor may include at least one of an accelerometer or a gyro sensor, but it is not limited thereto.

Referring to FIG. 9B, the first external electronic device 221 may include a processor (e.g., including processing circuitry) 901, memory 902, communication circuitry 903, a vibration motor (or a haptic motor) 904, a sensor 905, and/or a display 701.

The processor 901 may include various processing circuitry and control overall operations of the first external electronic device 221. For example, the processor 901 may transmit data to the electronic device 101 or receive data from the electronic device 101 by controlling the communication circuitry 903. Although not illustrated, the first external electronic device 221 may include an antenna for transmitting and/or receiving data. For example, the processor 901 may store first haptic data and/or first reference data received from the electronic device 101 in the memory 902. The description of the processor 120 in FIG. 1 above applies equally to the processor 901 and thus a repeated description may not be provided here.

The memory 902 may store instructions which, when executed by the processor 901 individually or collectively, cause operations of the first external electronic device 221. For example, the processor 901 may control an operation of the vibration motor 904 based on the first haptic data. The vibration motor 904 may be configured to provide a first haptic notification based on the first haptic data. The vibration motor 904 may provide a haptic notification to notify occurrence of an event related to the first external electronic device 221.

For example, the sensor 905 may be used to measure motions of a first user wearing the first external electronic device 221. For example, the sensor 905 may include an accelerometer 906 and/or a gyro sensor 907, but is not limited thereto. For example, when the first external electronic device 221 is a smartwatch worn on a wrist of the first user, movement of the wrist may be caused by motion of the first user, thereby changing a position and/or orientation of the wrist. Based on a change in the position and/or orientation of the wrist, the sensor 905 may generate data representing the motion of the first user. The accelerometer 906 may generate data indicating acceleration of the first external electronic device 221. The gyro sensor 907 may generate data indicating angular velocity of the first external electronic device 221. Based on the data, the processor 901 may generate data related to the motion of the first user.

FIG. 9C includes graphs, including a graph 900a representing data regarding velocity and a graph 900b representing data regarding acceleration obtained by the sensor 905 when a user performs a specific motion. For example, in a case in which the first external electronic device 221 is a smartwatch, when the user performs a specific motion while wearing the smartwatch, a position and posture of the smartwatch may change. Within a section 900c in which the position and posture of the smartwatch change, the graph 900a representing data regarding velocity and, within a section 900d in which the position and posture of the smartwatch change, the graph 900b representing data regarding acceleration may represent a waveform based on the motion of the user. Data according to the waveform may be generated by the sensor 905, and the sensor 905 may provide the data to the processor 901. The processor 901 may generate data related to the motion of the first user based on the data. The graphs 900a and 900b illustrated in FIG. 9C are merely examples and are not limited thereto.

Reference numeral 951 of FIG. 9D schematically illustrates a first haptic notification. Reference numeral 952 of FIG. 9D schematically illustrates a first reference motion based on first haptic data. Reference numeral 953 of FIG. 9D schematically illustrates an actual motion of a first user. Reference numeral 954 of FIG. 9D is a graph of velocity represented by the actual motion of the first user. Reference numeral 955 of FIG. 9D is a graph of acceleration represented by the actual motion of the first user. Reference numeral 956 of FIG. 9D indicates whether the first reference motion and the actual motion of the first user correspond. Reference numeral 956 of FIG. 9D may be displayed as O when the first reference motion and the actual motion of the first user correspond, and may be displayed as X when the first reference motion and the actual motion of the first user do not correspond.

Referring to reference numeral 951 of FIG. 9D, the first haptic notification provided from the vibration motor based on the first haptic data may include a first type for guiding a moving pose and a second type for guiding a static pose. For example, within a section 957 in which first haptic data of the first type for guiding a moving pose is provided, a moving pose of a user may be guided. Within the section 957, a motion requiring movement of the user may be guided. For example, within a section 958 in which first haptic data of the second type for guiding a static pose is provided, a static pose of the user may be guided. Within the section 958, a motion not requiring movement of the user may be guided.

Referring to reference numeral 952 of FIG. 9D, within the section 957 in which first haptic data of the first type is provided, reference motion of the first user may be a moving pose, and within the section 958 in which first haptic data of the second type is provided, reference motion of the first user may be a static pose. Referring to reference numerals 953, 954, and 955 of FIG. 9D, velocity and acceleration measured by motion of the first user may be represented based on an actual motion of the first user. When the first user performs a moving pose, velocity may appear higher than a reference velocity, and acceleration may appear higher than a reference acceleration. When the first user performs a moving pose, data related to the motions of the first user obtained through a sensor (e.g., the sensor 905 of FIG. 9B) may indicate data higher than the reference velocity and the reference acceleration. When the first user performs a static pose, velocity may appear lower than the reference velocity, and acceleration may appear lower than the reference acceleration. When the first user performs a static pose, data related to the motions of the first user obtained through the sensor may indicate data lower than the reference velocity and the reference acceleration.

At a timing at which the first reference motion is a moving pose, when data related to the motion of the first user indicates data higher than the reference velocity and the reference acceleration, a processor 120 (e.g., the processor 901 of FIG. 9B) may determine that the first reference motion and the actual motion of the first user correspond. At a timing at which the first reference motion is a static pose, when data related to the motion of the first user indicates data lower than the reference velocity and the reference acceleration, the processor 901 may determine that the first reference motion and the actual motion of the first user correspond. The processor 901 may calculate similarity between the actual motion of the first user and the first reference motion. In the example illustrated in FIG. 9D, the similarity may be calculated as 10/12×100=83.3%.

The above descriptions have been described with reference to the first external electronic device 221 as an example, but the descriptions of FIG. 9B may be applied to all of the one or more external electronic devices 220.

Referring back to FIG. 9A, the first external electronic device 221 may receive first reference data (e.g., the first reference data 331 of FIG. 3B) based on first haptic data from the electronic device 101. The first external electronic device 221 may measure a motion of a first user wearing the first external electronic device 221. The first external electronic device 221 may generate data related to the motion of the first user using a sensor (e.g., the sensor 905 of FIG. 9B). The first external electronic device 221 may compare the data related to the motion of the first user with the reference data for the first haptic data and calculate a first similarity between the data related to the motion of the first user and the reference data for the first haptic data. The first similarity may be represented as a percentage between 0% and 100%. For example, when the data related to the motion of the first user generated by measuring the motion of the first user fully corresponds to the first reference data, the first similarity may be 100%. When the data related to the motion of the first user does not fully correspond to the first reference data, the first similarity may be 0%. The above descriptions may be equally applied to a second external electronic device 222 and a third external electronic device 223. The second external electronic device 222 may calculate a second similarity between data related to a motion of a second user and second reference data (e.g., the second reference data 332 of FIG. 3B). The third external electronic device 223 may calculate a third similarity between data related to a motion of a third user and third reference data (e.g., the third reference data 333 of FIG. 3B).

According to an embodiment, each of the one or more external electronic devices 220 may transmit similarity data representing the calculated similarity to the electronic device 101. The first external electronic device 221 may transmit first similarity data representing the first similarity to the electronic device 101. The second external electronic device 222 may transmit second similarity data representing the second similarity to the electronic device 101. The third external electronic device 223 may transmit third similarity data representing the third similarity to the electronic device 101.

According to an embodiment, the electronic device 101 may calculate the ranking of motions of each of the one or more users based on similarity data received from the one or more external electronic devices 220. For example, the ranking may be calculated in order of higher similarity. For example, when the first similarity data is approximately 90%, the second similarity data is approximately 80%, and the third similarity data is approximately 70%, the electronic device 101 may calculate the ranking in an order of a first object, a second object, and a third object.

According to an embodiment, the electronic device 101 may display the calculated ranking on the video while the video is being played back. As illustrated in FIG. 9A, the ranking may be displayed on the video mirrored to the display device 230. For example, the ranking may include text 910 and/or an image 920 representing a similarity value, but is not limited thereto. The similarity value may be converted into a score and displayed. For example, when the similarity value is 90%, the similarity value may be converted into 90 points and displayed. While the video is being played back, the electronic device 101 may receive similarity data in real time. The electronic device 101 may calculate a real-time ranking based on the similarity data received in real time and provide the calculated ranking through the display device 230. One or more users practicing a group dance may check a real-time ranking through the ranking displayed on the video mirrored to the display device 230.

The electronic device 101 according to an embodiment may provide an evaluation in real time for motions of one or more users participating in group dance practice while the video is being played back.

FIG. 10 is a flowchart illustrating an example operation in which an electronic device calculates a ranking based on similarity data and displays the calculated ranking on a video according to various example embodiments.

According to an embodiment, instructions stored in memory (e.g., the memory 130 of FIG. 2), when executed by a processor (e.g., the processor 120 of FIG. 2) individually or collectively, may cause an electronic device (e.g., the electronic device 101 of FIG. 2) to perform operations described in FIG. 10.

Referring to FIG. 10, in operation 1001, the electronic device 101 may receive one or more similarity data from one or more external electronic devices (e.g., the one or more external electronic devices 220 of FIG. 2).

For example, a first external electronic device (e.g., the first external electronic device 221 of FIG. 2) may generate data related to motions of a first user by measuring actual motions of the first user. The first external electronic device 221 may calculate similarity between the data related to the motions of the first user and first reference data (e.g., the first reference data 331 of FIG. 3B) and transmit first similarity data representing the calculated similarity to the electronic device 101. The electronic device 101 may receive the first similarity data from the first external electronic device 221, receive second similarity data from a second external electronic device (e.g., the second external electronic device 222 of FIG. 2), and receive third similarity data from a third external electronic device (e.g., the third external electronic device 223 of FIG. 2).

In operation 1003, the electronic device 101 may calculate a ranking based on the received similarity data.

For example, the electronic device 101 may calculate the ranking in order of higher similarity. For example, when the first similarity data is approximately 90%, the second similarity data is approximately 80%, and the third similarity data is approximately 70%, the electronic device 101 may calculate the ranking in an order of a first object, a second object, and a third object.

In operation 1005, the electronic device 101 may display the ranking on the video.

For example, the electronic device 101 may display similarity data and the ranking on the video while the video is being played back. The ranking may be displayed on the video mirrored to a display device 230. As described above with reference to FIG. 9A, one or more users may check the ranking displayed in real time while the video is being played back.

In operation 1007, the electronic device 101 may provide feedback to each of the one or more external electronic devices 220.

For example, the electronic device 101 may calculate an overall score for all of the one or more users through similarity data received from the one or more external electronic devices 220. The overall score may be referred to as an average of the similarity data, but is not limited thereto. For example, when the first similarity is 90%, the second similarity is 80%, and the third similarity is 70%, the overall score may be calculated as 80 points. By providing the overall score, the electronic device 101 may provide feedback on overall completion of a group dance.

FIG. 11A is a flowchart illustrating an example operation in which an electronic device provides feedback according to various example embodiments. FIG. 11B is a diagram illustrating example similarity with respect to a timeline according to various example embodiments.

According to an embodiment, instructions stored in memory (e.g., the memory 130 of FIG. 2), when executed by a processor (e.g., the processor 120 of FIG. 2) individually or collectively, may cause an electronic device (e.g., the electronic device 101 of FIG. 2) to perform operations described in FIG. 11A.

The electronic device 101 according to an embodiment may provide feedback to one or more users regarding portions that require practice. For example, by analyzing similarity data received from one or more external electronic devices 220, the electronic device 101 may identify a section of a video having overall low similarity (e.g., a section 1124 of FIG. 11B). The electronic device 101 may provide intensive practice for the section by providing information for outputting haptic data corresponding to the section to the one or more external electronic devices 220.

Referring to FIG. 11A, in operation 1101, the electronic device 101 may identify, in haptic data, a section with low similarity based on similarity data received from the one or more external electronic devices 220.

For example, a section having low similarity may be referred to as a section having similarity less than or equal to a reference value in the haptic data. Referring to FIG. 11B, reference numeral 1111 of FIG. 11B represents a first similarity based on first similarity data received from a first external electronic device (e.g., the first external electronic device 221 of FIG. 2) with respect to a timeline of the video, and reference numeral 1112 of FIG. 11B represents a second similarity based on second similarity data received from a second external electronic device (e.g., the second external electronic device 222 of FIG. 2) with respect to the timeline of the video. The first similarity and the second similarity may include a section 1121 having 100% similarity, a section 1122 having similarity lower than 100% but exceeding the reference value, and a section 1123 having similarity less than or equal to the reference value. The electronic device 101 may identify the section 1123 having similarity less than or equal to the reference value in the first and second similarity data.

According to an embodiment, the electronic device 101 may identify, in the haptic data, a section having low similarity in which one or more users have overall low similarity. Reference numeral 1113 of FIG. 11B represents similarity for all of the one or more users. The electronic device 101 may identify a section 1124 having overall low similarity with respect to a timeline in which sections 1123 having similarity less than or equal to the reference value overlap.

Referring back to FIG. 11A, in operation 1103, the electronic device 101 may provide information for outputting haptic data corresponding to the section having low similarity to the one or more external electronic devices 220.

According to an embodiment, the electronic device 101 may transmit, in the haptic data, information for outputting haptic data corresponding to the section (e.g., the section 1124 of FIG. 11B) having low similarity identified in operation 1101 to the one or more external electronic devices 220. The one or more external electronic devices 220 may receive the information for outputting haptic data corresponding to the section having low similarity, and may provide haptic data of the section based on the information.

For example, the one or more external electronic devices 220 may select, in the haptic data, a timestamp corresponding to the section. Users of the one or more external electronic devices 220 may be provided with haptic data corresponding to the section by selecting the timestamp corresponding to the section. The one or more users may practice motions of the section having low similarity through the haptic data corresponding to the section. For example, the first external electronic device 221 capable of controlling playback of the video may enable the one or more users to repeatedly practice the section by selecting the timestamp corresponding to the section having low similarity.

According to an embodiment, when the electronic device 101 identifies the section 1124 having low similarity, the section may be identified such that natural motion may be guided. For example, the electronic device 101 may identify a start point or an end point of the section as a section in which motion naturally starts or naturally ends.

According to an embodiment, the electronic device 101 may provide haptic data for guiding motion for hearing-impaired users. In a case of hearing-impaired users, since sound cannot be heard, it may be difficult to learn or practice motion. For example, when a hearing-impaired user learns dance, the user may practice dance by feeling vibration generated from a speaker with a hand, but since the hand cannot be freely used, it may be difficult to learn a group dance.

According to an embodiment, since motion may be guided through haptic notifications provided from one or more external electronic devices 220 worn by one or more users, hearing-impaired users may also learn or practice a group dance. Through synchronized haptic notifications for a group dance, hearing-impaired users may learn and practice the group dance.

According to an example embodiment, an electronic device 101 is provided. The electronic device 101 may comprise a display 160. The electronic device 101 may comprise a camera 180. The electronic device 101 may comprise wireless communication circuitry 192 for wirelessly connecting with external electronic devices 220. The electronic device 101 may comprise a processor 120. The electronic device 101 may comprise memory 130 storing instructions. The instructions, when executed by the processor 120 individually and/or collectively, may cause the electronic device 101 to obtain a video through the camera 180, obtain haptic data related to motions of objects included in the video, generate a group of the external electronic devices 220 connected through the wireless communication circuitry 192, assign one object among the objects to each of the external electronic devices 220, transmit haptic data corresponding to the assigned one object to each of the external electronic devices 220, and transmit a signal for initiating output of the haptic data corresponding to the one object to the external electronic devices 220, based on receiving a first user input for playback of the video and for outputting the haptic data.

According to an example embodiment, the instructions, when executed by the processor 120 individually or collectively, may cause the electronic device 101 to broadcast, based on receiving the first user input, the signal transmitted to each of the external electronic devices 220, such that each of the external electronic devices 220 outputs a synchronized haptic notification.

According to an example embodiment, the instructions, when executed by the processor 120 individually or collectively, may cause the electronic device 101 to, when generating the group, set the number of the external electronic devices 220 participating in the group, and based on the generation of the group, transmit, through short-range wireless communication, information for displaying a user interface (UI) for joining the group and information used for selecting the one object among the objects to the external electronic devices 220.

According to an example embodiment, the instructions, when executed by the processor 120 individually or collectively, may cause the electronic device 101 to, based on receiving, from each of the external electronic devices 220, a signal indicating participation input through the UI, add each of the external electronic devices 220 that transmitted the signal to the group.

According to an example embodiment, the instructions, when executed by the processor 120 individually or collectively, may cause the electronic device 101 to receive a signal indicating selection of the one object among the objects from the external electronic devices 220, and based on receiving the signal, assign the one object to the external electronic device that transmitted the signal.

According to an example embodiment, the instructions, when executed by the processor 120 individually or collectively, may cause the electronic device 101 to transmit, to a first external electronic device 221 to which a first object among the objects is assigned, first haptic data corresponding to a first motion of the first object, and transmit, to a second external electronic device 222 to which a second object among the objects is assigned, second haptic data corresponding to a second motion of the second object. The first haptic data may be different from the second haptic data.

According to an example embodiment, the first user input may be a user input provided from a first external electronic device 221 among the external electronic devices 220, the first external electronic device 221 being capable of controlling playback of the video.

According to an example embodiment, the instructions, when executed by the processor 120 individually or collectively, may cause the electronic device 101 to, based on receiving the first user input, perform playback of the video, and while the video is being played back, control the playback of the video based on receiving, from the first external electronic device 221, a second user input for controlling the playback of the video.

According to an example embodiment, the controlling the playback of the video may include at least one of pausing the video, resuming playback of the paused video, stopping playback of the video, moving a timestamp of the video, adjusting a playback speed of the video, or repeating a designated section of the video.

According to an example embodiment, the instructions, when executed by the processor 120 individually or collectively, may cause the electronic device 101 to, while the video is being played back, receive similarity data from the external electronic devices 220, the similarity data indicating similarity between data related to motions of users wearing the external electronic devices 220 and reference data determined based on the haptic data, and based on the received similarity data, calculate a ranking of the motions of the users.

According to an example embodiment, the instructions, when executed by the processor 120 individually or collectively, may cause the electronic device 101 to obtain the reference data from another external electronic device 210, and transmit the reference data when transmitting the haptic data to the external electronic devices 220.

According to an example embodiment, the instructions, when executed by the processor 120 individually or collectively, may cause the electronic device 101 to, based on the similarity data received from the external electronic devices 220, identify, in the haptic data, a section having similarity less than or equal to a reference value, and provide, to the external electronic devices 220, information for outputting haptic data corresponding to the identified section within the video.

According to an example embodiment, the instructions, when executed by the processor 120 individually or collectively, may cause the electronic device 101 to, while the video is being played back, mirror the video to a display device 230, and display the ranking on the video.

According to an example embodiment, the haptic data may be haptic data generated by extracting the motion of the object in the video using an artificial intelligence model and generating the haptic data based on the extracted motion.

According to an example embodiment, a method of an electronic device 101 is provided.

The method may comprise obtaining a video and haptic data. The method may comprise generating a group of one or more external electronic devices 220 for guiding motions of one or more objects included in the video. The method may comprise assigning one object among the one or more objects to each of the one or more external electronic devices 220. The method may comprise transmitting, to each of the one or more external electronic devices 220, the haptic data corresponding to the one object assigned to each of the one or more external electronic devices 220. The method may comprise transmitting, to each of the one or more external electronic devices 220, a signal for initiating output of the haptic data corresponding to the one object, based on receiving a first user input for playback of the video and for outputting the haptic data.

According to an example embodiment, the method may further comprise broadcasting the signal transmitted to the one or more external electronic devices 220 based on receiving the first user input, such that each of the one or more external electronic devices 220 outputs a synchronized haptic notification.

According to an example embodiment, the method may further comprise setting the number of the one or more external electronic devices 220 participating in the group, when generating the group. The method may further comprise transmitting, through short-range wireless communication, information for displaying a user interface (UI) for joining the group and information used for selecting the one object among the one or more objects to the one or more external electronic devices 220 based on the generation of the group.

According to an example embodiment, the method may further comprise, based on receiving, from the one or more external electronic devices 220, a signal indicating participation input through the UI, adding the one or more external electronic devices 220 that transmitted the signal to the group.

According to an example embodiment, the method may further comprise mirroring the video to a display device 230 while the video is being played back.

According to an example embodiment, an electronic device 101 is provided. The electronic device 101 may comprise a processor 120. The electronic device 101 may comprise memory 130 storing instructions. The instructions, when executed by the processor 120 individually or collectively, may cause the electronic device 101 to obtain a video and haptic data, generate a group of external electronic devices 220 for guiding motions of one or more objects included in the video, assign one object among the one or more objects to the one or more external electronic devices 220, transmit the haptic data corresponding to the one object assigned to the external electronic device 220 to the external electronic device 220, and transmit a signal for initiating output of the haptic data corresponding to the one object to the external electronic device 220, based on receiving a first user input for playback of the video and for outputting the haptic data.

A non-transitory computer-readable storage medium is provided. The non-transitory computer-readable storage medium may store a program including instructions. The instructions, when executed by a processor 120 of an electronic device 101 individually and/or collectively, may cause the electronic device 101 to obtain a video and haptic data from an external electronic device 210. The instructions, when executed by the processor 120 of the electronic device 101 individually or collectively, may cause the electronic device 101 to generate a group of a plurality of external electronic devices 220 for guiding motions of each of a plurality of objects included in the video. The instructions, when executed by the processor 120 of the electronic device 101 individually or collectively, may cause the electronic device 101 to assign each of the plurality of objects to each of the plurality of external electronic devices 220. The instructions, when executed by the processor 120 of the electronic device 101 individually or collectively, may cause the electronic device 101 to transmit, to the plurality of external electronic devices 220, the haptic data corresponding to the object assigned to each of the plurality of external electronic devices 220. The instructions, when executed by the processor 120 of the electronic device 101 individually or collectively, may cause the electronic device 101 to transmit a signal for initiating output of the haptic data to the plurality of external electronic devices 220, based on receiving a first user input for playback of the video and for outputting the haptic data.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a display;
a camera;
wireless communication circuitry configured to communicate with external electronic devices;
at least one processor comprising processing circuitry; and
memory including one or more storage media storing instructions,
wherein the instructions, when executed by the at least one processor individually or collectively, cause the electronic device to:
obtain a video through the camera;
obtain haptic data related to motions of objects included in the video;
generate a group of the external electronic devices connected through the wireless communication circuitry;
assign one object among the objects to each of the external electronic devices;
transmit haptic data corresponding to the one object to each of the external electronic devices; and
transmit a signal for initiating output of the haptic data corresponding to the one object to the external electronic devices, based on receiving a first input for playback of the video and for outputting the haptic data.

2. The electronic device of claim 1,
wherein the instructions, when executed by the at least one processor individually or collectively, cause the electronic device to, based on receiving the first input, broadcast the signal transmitted to each of the external electronic devices, such that each of the external electronic devices outputs a synchronized haptic notification.

3. The electronic device of claim 1,
wherein the instructions, when executed by the at least one processor individually or collectively, cause the electronic device to:
when generating the group, set the number of the external electronic devices participating in the group; and
based on the generation of the group, transmit, through short-range wireless communication, information for displaying a user interface (UI) for joining the group and information used for selecting the one object among the objects to the external electronic devices.

4. The electronic device of claim 3,
wherein the instructions, when executed by the at least one processor individually or collectively, cause the electronic device to, based on receiving, from each of the external electronic devices, a signal indicating participation input through the UI, add each of the external electronic devices that transmitted the signal to the group.

5. The electronic device of claim 3,
wherein the instructions, when executed by the at least one processor individually or collectively, cause the electronic device to:
receive a signal indicating selection of the one object among the objects from the external electronic devices; and
based on receiving the signal, assign the one object to the external electronic device that transmitted the signal.

6. The electronic device of claim 5,
wherein the instructions, when executed by the at least one processor individually or collectively, cause the electronic device to:
transmit, to a first external electronic device to which a first object among the objects is assigned, first haptic data corresponding to a first motion of the first object; and
transmit, to a second external electronic device to which a second object among the objects is assigned, second haptic data corresponding to a second motion of the second object, and
wherein the first haptic data is different from the second haptic data.

7. The electronic device of claim 1,
wherein the first input is an input provided from a first external electronic device among the external electronic devices, the first external electronic device being capable of controlling playback of the video.

8. The electronic device of claim 7,
wherein the instructions, when executed by the at least one processor individually or collectively, cause the electronic device to:
based on receiving the first input, perform playback of the video; and
while the video is being played back, control the playback of the video based on receiving, from the first external electronic device, a second input for controlling the playback of the video.

9. The electronic device of claim 8,
wherein the controlling the playback of the video includes at least one of:
pausing the video;
resuming playback of the paused video;
stopping playback of the video;
moving a timestamp of the video;
adjusting a playback speed of the video; and/or
repeating a designated section of the video.

10. The electronic device of claim 1,
wherein the instructions, when executed by the at least one processor individually or collectively, cause the electronic device to:
while the video is being played back, receive similarity data from the external electronic devices, the similarity data indicating similarity between data related to motions of users wearing the external electronic devices and reference data determined based on the haptic data; and
based on the received similarity data, calculate a ranking of the motions of the users.

11. The electronic device of claim 10,
wherein the instructions, when executed by the at least one processor individually or collectively, cause the electronic device to:
obtain the reference data from another external electronic device; and
transmit the reference data when transmitting the haptic data to the external electronic devices.

12. The electronic device of claim 10,
wherein the instructions, when executed by the at least one processor individually or collectively, cause the electronic device to:
based on the similarity data received from the external electronic devices, identify, in the haptic data, a section having similarity less than or equal to a reference value; and
provide, to the external electronic devices, information for outputting haptic data corresponding to the identified section within the video.

13. The electronic device of claim 10,
wherein the instructions, when executed by the at least one processor individually or collectively, cause the electronic device to:
while the video is being played back, mirror the video to a display device including a display; and
display the ranking on the video.

14. The electronic device of claim 1,
wherein the haptic data includes haptic data generated by extracting the motion of the object in the video using an artificial intelligence model and generating the haptic data based on the extracted motion.

15. A method of an electronic device comprising:
obtaining a video and haptic data;
generating a group of one or more external electronic devices for guiding motions of one or more objects included in the video;
assigning, to each of the one or more external electronic devices, one object among the one or more objects;
transmitting, to the one or more external electronic devices, the haptic data corresponding to the one object assigned to each of the one or more external electronic devices; and
based on receiving a first input for playback of the video and for outputting the haptic data, transmitting, to each of the one or more external electronic devices, a signal for initiating output of the haptic data corresponding to the one object.

16. The method of claim 15, further comprising broadcasting the signal transmitted to the one or more external electronic devices based on receiving of the first input so that the one or more external electronic devices outputs a synchronized haptic notification.

17. The method of claim 15, further comprising:
setting the number of the one or more external electronic devices participating in the group, when creating the group; and
transmitting information for displaying a user interface (UI) for joining the group and information used to select the one object of the one or more objects to one or more external electronic devices, based on the creation of the above groups, through short range wireless communication.

18. The method of claim 17, further comprising adding an external electronic device, based on receiving a signal indicating participation input through the UI from the external electronic device of the one or more external electronic devices,

19. The method of claim 15, further comprising mirroring the video to a display device including a display, while the video is playing.

20. An electronic device comprising:
at least one processor comprising processing circuitry; and
a memory storing instructions,
wherein the instructions, when executed by the at least one processor, individually or collectively, cause the electronic device to:
obtain a video and haptic data;
generate a group of an external electronic device to guide motions of one or more objects included in the video;
assign one object of the one or more of objects to the external electronic device;
transmit the haptic data corresponding to the one object assigned to the external electronic device to the external electronic device; and
transmit a signal to initiate output of the haptic data to the external electronic device based on receiving of a first input for playing the video and outputting the haptic data corresponding to the one object.
